(19) United States
(12) Patent Application Publication
(10) Pub. No.: US 2025/0025848 A1
(43) Pub. Date: Jan. 23, 2025

(54) PROCESS AND APPARATUS FOR PRODUCING HYDROGEN BY CRACKING METHANE AND LOW CO2 EMISSION HYDROCARBONS

(71) Applicant: NEXTCHEM TECH S.p.A, Roma (IT)

(72) Inventors: Michael EPSTEIN, LeZion (IL); Gaetano IAQUANIELLO, Rome (IT); Annarita SALLADINI, Roseto degli Abruzzi (IT); Alessia BORGOGNA, Pescara (IT); Emma PALO, Battipaglia (IT)

(21) Appl. No.: 18/710,073

(22) PCT Filed: Nov. 14, 2022
(86) PCT No.: PCT/IB2022/060932

§ 371 Date: May 14, 2024

(30) Foreign Application Priority Data
Nov. 16, 2021 (IT) 102021000029045

(51) Int. Cl. B01J 10/00; B01J 19/08; C01B 3/24; C01B 32/05

(52) U.S. Cl. CPC B01J 10/005; B01J 19/087; C01B 3/24; C01B 32/05; B01J 2219/0809; B01J 2219/0837; B01J 2219/0869; B01J 2219/0871; C01B 2203/0272; C01B 2203/1235

(57) ABSTRACT

A hydrocarbon cracking process for producing gaseous hydrogen and solid carbon in a medium consisting of a pool of molten metals and/or salts, characterized in that the heat required for the cracking reaction is supplied to said molten pool by circulating an electric current directly in said molten pool obtained by applying an electric field supplied by electrodes immersed in said molten pool.

The invention relates to a process and apparatus for developing a cracking reaction of hydrocarbon feeds so as to obtain a stream of gaseous hydrogen and solid carbon by means of a process which minimizes or totally eliminates CO₂ emissions into the atmosphere; this is obtainable, according to the present invention, by a process in which the cracking reaction is developed inside a molten pool consisting of molten metals and/or molten salts in which the heat required for the cracking reaction is supplied by the electric current produced by applying an electric field by means of electrodes directly immersed in said molten pool.

It is known that the conversion of natural gas or other hydrocarbons into H₂ can be carried out by different methods; for example, among those most used today, steam reforming (SR), autothermal reforming (ATR), partial oxidation with catalyst (CPO), or without catalyst (POx) can be mentioned.

In particular, partial oxidation in the absence of catalyst (POx) is preferably used for the gasification of heavy residues deriving from refinery activities, or even for the gasification of coke or other compounds originating from biomass.

In all the aforementioned technologies, the carbon atoms are converted into carbon dioxide (CO₂) resulting in a significant CO₂ emission associated with the production of said H₂.

For example, natural gas (NG) Steam Reforming is commonly used for the production of about 94% v/v of the world's H₂ production; this process releases about 10 kg of CO₂ per kg of H₂ produced.

Therefore, an apparatus for the conversion of natural gas (NG), or in any case of hydrocarbons, into H₂, which avoids or in any case minimizes CO₂ emissions, is highly desirable.

From this point of view, cracking natural gas inside a molten medium, for example in a molten metal and/or molten salt in the presence or absence of a catalyst, is an option and a very interesting alternative for producing H₂ without CO₂ emissions.

As known, the cracking reaction of methane (1) is sufficiently endothermic, as shown by the following reaction:

$${CH}_{4 ( g )} \to {C}_{( s )} + 2 {H}_{2 ( g )} ΔH = 74 kJ / mol \qquad ( 1 )$$

However, methane cracking is only one example of the simplest case of a wide range of saturated hydrocarbons which can be cleaved by breaking the C—H bond.

In fact, considering that the general formula for saturated acyclic hydrocarbons, i.e., alkanes, is CₙH₂ₙ₊₂, the general cracking reaction can be written as follows:

$${C}_{n} {H}_{2 n + n} \to {n C}_{( s )} + ( n + 1 ) {H}_{2} \qquad ( 2 )$$

Furthermore, the alkanes can be branched and/or saturated cyclic hydrocarbons, in addition to linear molecules, and are the basis of petroleum fuels.

Specific examples of alkane cracking are given in reactions 3 and 4 for propane and hexane, respectively:

$${C}_{3} {H}_{8} \to 3 {C}_{( s )} + 4 {H}_{2} \qquad ( 3 )$$

$${C}_{6} {H}_{14} \to 6 {C}_{( s )} + 7 {H}_{2} \qquad ( 4 )$$

In the configurations of liquid metal and/or molten salt reactors, known from the prior art and previously described and in which the methane cracking reaction occurs, external heating is generally used, for example by furnaces, through which the combustion heat is transferred to the molten medium.

Clearly, if fossil fuels are used to heat the reactor, the use thereof is such that they are CO₂ emitters and this would nullify part of the CO₂ emission savings which would instead be obtained by using the process according to reaction (1) to produce H₂, where CO₂ is not produced.

Similarly, burning H₂ is a possible solution to the problem of CO₂ emissions, but it obviously reduces the attractiveness of the final product of H₂, which will inexorably be consumed to meet the thermal needs of the reactor.

Processes are known in which the heating is carried out by electrical elements surrounding the reactor, heating its walls; said hot walls thus transmit heat to the molten metal, for example tin, by convection and conduction.

In an industrial capability reactor this method creates a temperature gradient between the wall and the mass of the molten metal, causing uneven heating which is reflected in a decrease in the conversion yield of CH₄ or, more generally, of hydrocarbons conversion.

Furthermore, in the CH₄ cracking process inside the liquid metal, gas bubbles are formed in the reactor, linked to the distribution of the feed gas inside the molten metal bed; this implies, for technologies which use external heating, a reduction in the transfer of heat from the wall to the mass, due exactly to the generation of a higher temperature gradient, from which derives, in addition to the reduction of the efficiency of the electric heater, also a shortening of the life thereof.

Finally, still in industrial capability reactors, the combination of the operating temperature (900-1300° C.) and the molten medium, for example tin, does not allow the construction of walls made of metal, but rather of alloys with a high nickel content, such as Inconel, while the area of contact with the tin must be covered with a layer of ceramic bricks which create insulation but at the same time generate a resistance to heat transfer from the external heating.

For all the above reasons, heating is the main obstacle to the use of CH₄ cracking technology in molten metal or salt reactors, in particular when CO₂ emissions are to be minimized by using renewable energy for such a heating.

Even the solution of circulating a molten metal flow outside the reactor, such as tin, and heating it separately in an electric heat exchanger before recirculating it to the reactor, shows several problems mainly due to the fact that any metal used on the side cooling circuit is subject to a severe corrosion attack by the molten metal, which corrosion is accentuated by the operating temperatures of the reactor, which can typically be in the range between 90° and 1300° C.

Some application examples of cracking in the presence of a molten medium are shown below.

The paper “Catalytic molten metals for the direct conversion of methane to hydrogen and separable carbon” by D. Chester Upham et al, Science 358, 917-921 (2017), shows the performance of systems consisting of active metals (such as Ni, Pt, Pd) dissolved in non-active molten metals at low melting point (such as In, Ga, Sn, Pb) for the conversion of methane (CH₄) to hydrogen (H₂) and separable carbon; however, the paper does not specify the method used to heat and maintain the molten metal at the optimal temperature for the conversion of the load.

The paper “Fossil fuel decarbonation technology for mitigating global warning” by M. Steinberg, Int. J. Hydrogen Energy 1999, 21, 771-777, describes a molten-pool reactor which is heated through a tubular heat exchanger by combustion of methane-air or hydrogen-air; unlike the present invention in this solution, the metal is kept molten by means of either the combustion of methane, with subsequent production of CO₂, or the consumption of hydrogen, thus leading to a consumption of the produced amount of this element.

In the study by Abanades et al. “Development of methane decarbonation based on liquid metal technology for CO₂-free production of hydrogen”, Int. J. Hydrogen Energy 2016, 41, 8150-8167, a reactor is disclosed containing liquid metal, a subsequent separation step of the carbon from the liquid metal, a separation step of the carbon from the gas, a separation step of the hydrogen from the gas, and then recycling the raw material (methane) which has not reacted to the reactor; furthermore, the heating of the reactor is performed either by the combustion of the hydrogen produced, or by the combustion of the raw material, alternatively anticipating the use of solar energy.

In the paper “Hydrogen production using methane: techno-economics of decarbonizing fuels and chemicals” by Parkinson et al., Int. J. Hydrogen Energy 2018, 43, 2540-2555, the suggested scheme comprises a reactor containing a liquid molten metal on the top of which there is a molten salt layer and in which the reaction heat is supplied by an external furnace.

It is a fact, as can also be seen from the papers cited, that the cracking reaction of natural gas, being endothermic, requires the administration of heat.

However, if hydrogen is to be produced without CO₂ emissions, it is apparent that such a heat must not be supplied by the combustion of fossil fuels.

Renewable or “green” electricity is a good solution to this problem, as described for example in the patents below.

Patent WO 2020/200522 A1 describes a geometry of endothermic reactors where the reaction zone consists of electrically conductive solid particles which are heated by means of the application of an electric field.

Unlike the present invention, however, a solid bed and not a molten metal is used as a heat conductor for developing the cracking reaction.

Patent U.S. Pat. No. 2,799,640, Jul. 16, 1957, describes a method and an apparatus for chemical reactions activated by electrocution; in this case, a fluidized bed reactor is disclosed in which said bed consists of conductive solid particles among which high melting temperature metals are expressly mentioned.

Patent U.S. Pat. No. 2,982,622, May 2, 1961, describes a method for converting a feed consisting of hydrocarbons (900-1700° C.) into hydrogen and pure carbon by means of electric current, in areas where the cost of electric energy is relatively low; also in this case a fluidized bed consisting of inert solid particles, or solid carbon-based particles, is included in the reaction zone.

Patent AT 175243 discloses an electric furnace having two vertically arranged electrodes adapted to transfer current to the bulk material present in the furnace compartment; the bulk material described can either participate in the reaction as a reagent, and thus be consumed by the same reaction, or act as a means for transmitting the generated heat; however, no mention is made of the use of molten metals and/or molten salts.

Patent CH 278580 discloses a blast furnace having two vertically arranged annular electrodes for transferring current to the bulk material present in said blast furnace; also in this case the bulk material described can either participate in the reaction, as a reagent, and thus be consumed by the same reaction, or act as a means for transmitting the generated heat.

The aim of the present invention is to overcome the limits of the prior art by providing an apparatus capable of converting natural gas, or in any case hydrocarbons, into hydrogen (H₂), reducing or avoiding the conversion into CO₂ and, therefore, the emissions of the latter into the atmosphere, in a medium consisting of molten metal and/or salt.

The suggested solution is to use a conversion reactor in which the heat required for the hydrocarbon conversion reaction into hydrogen and carbon is supplied by means of an electric current which propagates within a molten metal and/or salt appropriately controlled through the gas mass present in the bed, said gas mass consisting of the feed gas which is added to the recycle gas, with the addition, if any, of an inert material which lowers the conductivity of the molten pool.

A better understanding of the invention will be obtained from the following detailed description and with reference to the accompanying figures showing, by way of a non-limiting example, a preferred embodiment.

In the drawings:

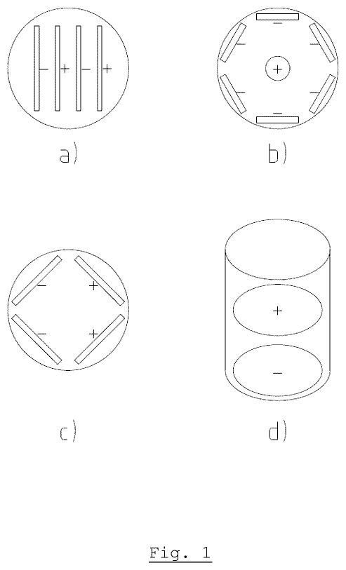

FIG. 1 shows preferred electrode arrangements within the conversion reactor.

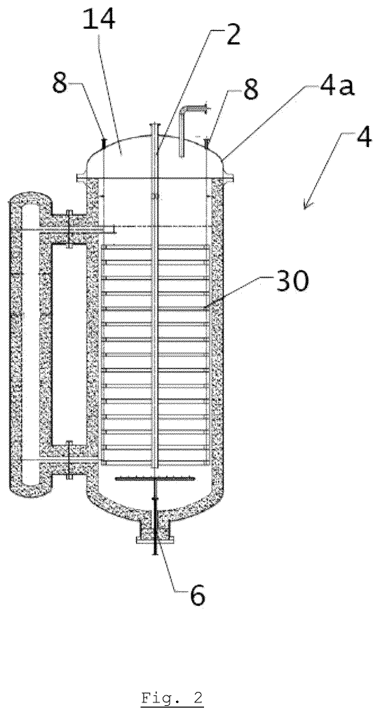

FIG. 2 shows a preferred embodiment of the same reactor.

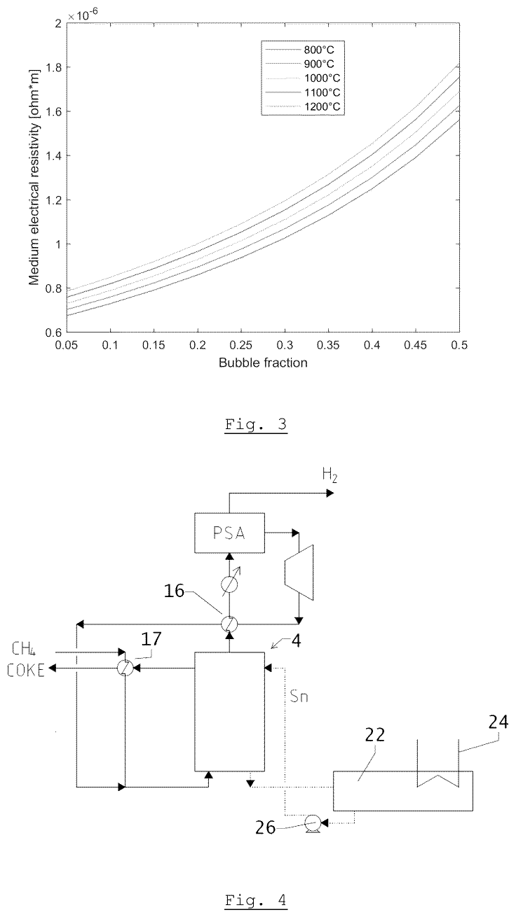

FIG. 3 shows the effect of the degree of vacuum on the average electrical resistivity of a molten tin bed.

FIG. 4 shows a diagram of the methane cracking process.

The present invention relates to a process and apparatus for cracking natural gas, or other saturated hydrocarbon, in a molten medium such as metal and/or salt, so as to obtain a hydrogen-rich gas phase and a carbonaceous solid phase.

Such a solution allows reducing or completely avoiding CO₂ emissions, normally related to the supply of the reaction heat through a heating furnace outside the conversion reactor, introducing a system directly into the reaction environment which exploits an electric current to generate the heat required for the cracking reaction through the Joule effect.

The solution disclosed is further capable of improving the heat transfer efficiency to the reactive species from a value of about 50%, considering the heating outside the reactor, to about 95%, while allowing the use of fossil fuels to be reduced or avoided and to allow the use of renewable energy sources to produce the required electricity consumption.

According to the invention, such an object is achieved by supplying the heat required for the cracking reaction by directly connecting the molten metal with an electrical circuit and then heating said molten metal pool, and/or molten salts, with the current passing therethrough.

This heating method is known as resistance heating, or ohmic heating, and includes the passage of an electric current through the medium and is obtainable by inserting electrodes directly into said molten medium; the natural resistance of the molten pool and the electrodes immersed therein, which we will indicate hereinafter for brevity “resistant system” to the passage 4 current generates heat, according to Joule's law, as universally known.

According to the invention, such a molten medium can be tin, lead, molten alloys such as Ni—Bi or molten salts and operates at a temperature below 1500° C., obtaining a hydrogen yield greater than 50%.

Since molten metals are relatively good conductors, having a low resistance to electric current, it is required to pass a large amount of current through the molten metal to transmit the necessary amount of heat for the cracking reaction to said molten metal; said power is calculated according to the following known formula:

P=I²*r=VI
P=power
I=current intensity
V=voltage
r=medium resistance

According to a peculiar feature of the invention, the feed, natural gas or other hydrocarbon to which the recycling of the unconverted gas is added, is blown, in the gas phase, at the bottom of the reactor in the molten metal, so that said gaseous stream uniformly crosses the entire molten pool.

This peculiarity has an advantage: the presence of gas bubbles inside the liquid metal creates an empty volume which increases the resistivity of the molten pool, thus reducing the current to supply to obtain a heat input useful for developing the reaction, as shown in FIG. 3.

Furthermore, the presence of gas bubbles affects the variation of the overall heat exchange coefficient, while allowing the removal of heat from the electrodes and favoring the heat exchange between the electrodes and the molten pool.

Basically, the conditions of the electric field are determined based on the average electric conductivity which exists in the resistant system (electrodes and molten pool) when it contains a certain amount of gas bubbles (empty volume): in fact, the presence of low conductivity material in the molten pool improves the control of the conductivity thereof and the removal of heat from the electrodes.

But there is further advantage: in fact, said electric field can also improve the kinetics of the cracking process due to the free radicals and ions contained within the gas bubbles, once the cracking temperatures are reached.

Furthermore, the heating is easily controllable according to the desired temperature of the medium inside the reactor, optimizing the current/voltage intensity conditions.

In a preferred, non-limiting embodiment, the voltage (V) to be applied to obtain the development of the cracking reaction is less than 100 V, more preferably is in the range of 5-75 V; furthermore the current intensity (I) applied is less than 500 A and the current density is in the range of 1-20 A/dm².

Power can also be applied in direct current (DC) mode if the source is, for example, a photovoltaic system.

In particular, the application of a direct current allows having more effective control on the conversion of the power supply into hydrogen with the same electrical conductivity; moreover, advantageously, when the electricity is generated from a renewable source, such as photovoltaic or wind energy, the entire cracking process is completely free of CO₂ emissions.

According to the invention, the heating method now described can be applied to either a molten metal, or an alloy as previously indicated, or to a molten metal in which a homogeneous catalyst is dissolved or alloyed, by way of non-limiting example, a small percentage of Ni.

Furthermore, different electrode arrangements and configurations are possible, as shown in FIG. 1, said electrodes being able to be arranged vertically parallel to each other (1a), or being able to be distributed along the walls of the reactor (1c), or with a central electrode and others along the walls (1b), or still one or more electrodes in the upper position and one or more electrodes in the lower position (1d).

According to the invention, the electrodes can be made of materials such as graphite, carbides (e.g., Sic, ZrC), nitrides (e.g., AlN), borides (e.g., ZrB2, ZnB2) as well as yttrium-stabilized zirconia (YsZr).

Up to an operating temperature of 1100-1200° C., the material SiC is an excellent substitute for graphite by virtue of the better mechanical properties and high availability.

As already described, the electrically heated reactor can contain an active catalytic metal melted or alloyed in the metal pool, so as to form a molten metal alloy, where the active metal is Ni or an Ni alloy such as Nickel-Gallium, or Gallium and alloys thereof, or copper (Cu) and the alloy thereof or any combination of the aforementioned metals.

Advantageously, the presence of a catalyst increases the single-passage conversion of the feed and lowers the operating temperature, approaching the thermodynamic limit of the methane cracking at that temperature.

The gas stream produced by the cracking reaction is rich in H₂ and can be directed to purification treatments (such as PSA) to obtain pure hydrogen while the unconverted gas is recycled and mixed with the feed; in this sense a general diagram is shown in FIG. 4.

Advantageously, the solid carbon obtained from the cracking reaction is insoluble with the molten metal and therefore will separate therefrom, accumulating on the upper surface from which it can be separated; this implies that the carbon advantageously does not saturate the molten metal and that therefore, in the presence of a catalyst dissolved in the molten pool, it is not able to poison or deactivate the catalyst.

According to the invention, various configurations of the electrodes immersed in the molten pool are possible.

For example, FIG. 1a shows a first arrangement in which the electrodes are arranged vertically inside the molten pool, parallel to the axis of the reactor, said electrodes being preferably, but not limited to, the plates.

A second arrangement is shown in FIG. 1b in which the anode is arranged centrally and can have the shape of a tube within which the CH₄ gas stream can flow by preheating, while the cathodes are arranged vertically along the axis of the reactor near the side surface of the same reactor, said cathodes being preferably, but not limited to, the plates.

A third arrangement is shown in FIG. 1c where the electrodes have a rectangular configuration and are arranged along the reactor walls, said electrodes being preferably, but not limited to, plates.

A fourth arrangement is shown in FIG. 1d where the electrodes are both circular in shape, or disks, arranged perpendicular to the axis of the reactor and positioned respectively at the bottom and top of the reactor.

In the preferred embodiment shown in FIG. 2, a central electrode (2), corresponding to the appropriately cooled anode, is surrounded in a cage by vertical electrodes (8), corresponding to the cathodes: said central electrode being of opposite polarity (+) with respect to the polarity possessed by the electrodes (−) forming the cage (30), allows the flow of the electric current, the intensity of which is controlled by the degree of vacuum of the reactor and the presence of inert materials.

In the embodiment described in FIG. 2, the natural gas and/or hydrocarbon conversion reactor to hydrogen and carbon consists of the following elements:
a metallic reactor (4) internally coated with refractory material which can operate between 900 and 1300 degrees C.;
a distributor (6) of the feed at the bottom of such a reactor which collects fresh feed and the unconverted recycle gas;
a system for preheating such a feed obtained both by cooling the anode and by cooling the converted gas before the purification step (16), and by thermal recovery (17) from the coke exiting the reactor;
a system of electrodes, i.e., anode (2) and cathode (8) inserted in the molten metal pool which allows the heating thereof and supplies the heat to the hydrocarbon cracking reaction;
a collection system (14) of the converted gas, installed in the vault (4a) of the reactor (4), which allows removing the converted gas, said gas mainly consisting of H₂ and CH₄ which, after appropriate cooling, is sent to a separation unit, such as a PSA (Pressure Swing Adsorption) unit, in which pure H₂ and a recycle gas is obtained which is recirculated and added to the fresh feed;
a carbon separation system;
a system for emptying and accumulating the molten metal/salt consisting of a tank (22), an electric heater (24) and recycling pumps (26); this system is provided with an apparatus for dosing any catalysts and/or inert material, such as ceramics, adapted to increase the resistance of the pool.

The conversion process described above is implementable both at moderate pressures and under medium/high pressure conditions: this allows the reactor to be appropriately sized according to the desired operating pressure and the subsequent steps downstream thereof.

In fact, if the reactor operates at a sufficiently high pressure, it is possible to optimize the entire gas circuit downstream of the reactor, since no intermediate compressor would be necessary to bring the converted gas to the pressure conditions suitable for the subsequent purification step in the PSA unit.

In the preferred embodiment described, the anode cooling can be achieved by preheating the natural gas feed flowing through the electrode itself, said electrode having the shape of a tube or by an external cooling medium such as water or air.

Furthermore, the electrode cage is supported by a structure thereof which allows the regular maintenance thereof.

According to the invention, the estimated energy consumption is in the range of 5-20 KWh per kg of hydrogen produced, better still in the range of 5-10 KWh per kg.

In the described preferred embodiment, the electrical resistance of the molten metal is controlled by the size and number of the natural gas bubbles and this is achieved by using a porous diffuser or spreaders.

In a preferred, non-limiting embodiment, the size of the bubbles will be less than 1 mm.

By way of example, it has been estimated that at 800° C. a conversion per step of 90% can be obtained in the presence of a suitable catalyst.

The method according to the invention is also usable with alternative feeds other than natural gas; in fact, the raw material to be treated could be any other fossil hydrocarbon either as gas or liquid or even organic waste streams.

Furthermore, it is possible to improve the reaction kinetics by immersing the filler material inside the molten medium to facilitate the heat transfer between the medium and the bubbles and by slowing the rate of rise of the bubble and increasing the residence time; said filler material is mainly ceramic which can have different shapes, for example rings, saddles, etc.

Although various embodiments have been provided in the present disclosure as illustrative and non-restrictive examples, it should be clear that the systems and methods disclosed can be incorporated into many other specific embodiments without departing from the spirit and scope of the present description.

Many other modifications, equivalents and alternatives, will become apparent to those skilled in the art once the above description has been fully appreciated. It is understood that the following statements shall be construed to encompass all such modifications, equivalents and alternatives where applicable.

From the above description, many advantages are apparent.

A first advantage of the invention consists in reducing, if not eliminating, CO₂ emissions in the hydrogen and hydrocarbon cracking process.

A second advantage of the heating method according to the invention is related to the scalability up to large diameter industrial capacity reactors, which usually consist of metal tanks internally coated with ceramic bricks; this allows solving one of the major problems encountered by most of the suggested prior art indicated above.

Furthermore, the method according to the invention efficiently uses electrical energy, is clean and produces uniform heating of the fluid without temperature gradients with respect to heating from the outside and through the walls of the molten metal reactor.

A further advantage of the invention consists in the better management of the chemical reaction, easily controllable, in terms of conversion, simply by controlling the value of the applied voltage.

Finally, a further advantage consists in that the solid carbon produced by the reaction naturally separates from the molten pool, not saturating the metal and, in case of the presence of a catalyst dissolved in the molten pool, does not deactivate or poison said catalyst; this translates into a better management of the catalyst itself which does not need constant regeneration.

The example shown in FIG. 3 shows how the resistivity of a molten tin bed varies according to the temperature and degree of vacuum of the bed, the latter directly connected to the fraction of bubbles present in the bed itself.

Taking a medium temperature of 800° C. as a reference, the electrical resistivity goes from 0.67, 0.94 and 1.55 ohm·m for a degree of vacuum of the molten tin pool of 5%, 25% and 50% respectively.

Based on these considerations, it was estimated that for the production of 100 Nm³/h of H₂, a power of about 50 KW is required, obtained for example by a voltage of about 100 V and a current of 500 A.

A greater capacity can be achieved by multiplying the number of modules or changing the electrode arrangement.

1. A hydrocarbon cracking reactor (4) for producing gaseous hydrogen and solid carbon in a medium consisting of a pool of molten metals and/or salts contained in said reactor, characterized in that the heat required for the cracking reaction is provided by the direct application of a voltage to said molten pool and, therefore, by the circulation of an electric current directly in said molten pool, said electric current being obtained by applying an electric field by means of electrodes immersed in said molten pool, said metal reactor being internally coated with refractory material and said metal reactor being suitable to operate at temperatures below 1500° C., preferably between 900° C. and 1300° C., and comprising:
at least one distributor (6) of the hydrocarbon feed at the bottom of said reactor which collects the fresh feed and the unconverted recycle gas;
at least one system for preheating such a feed;
a system of anode (2) and cathode (8) electrodes inserted in the molten metal pool which allows the heating thereof and supplies the heat to the hydrocarbon cracking reaction;
a converted gas collection system (14);
a system for separating/removing the carbon from the surface of the molten pool;
a system for emptying and accumulating the molten metal/salt;
wherein said feed preheating system is suitable to obtain the feed preheating by both cooling the anode and cooling the converted gas before the purification step (16) and cooling the carbon produced (17),
and wherein
said converted gas collection system is installed in the reactor vault and allows moving away the converted gas, mainly consisting of H₂ and CH₄, and directing it towards a subsequent purification step, after appropriate cooling.

2. The cracking reactor according to claim 1, characterized in that said system for emptying and accumulating the molten metal/salt consists of a tank (22), an electric heater (24) and recycling pumps (26) and is provided with an apparatus for dosing any catalysts and/or inert material, such as ceramics, adapted to increase the resistance of the molten pool.

3. The cracking reactor according to claim 1, characterized in that the medium consists of molten salts instead of the molten metal pool.

4. The reactor according to claim 1, characterized in that the hydrocarbon feed is bubbled at the bottom of the molten pool by means of a distributor (6), generating bubbles which increase the resistivity of the molten pool, thus reducing the current to be supplied to said pool to develop the cracking reaction.

5. The reactor according to claim 1, characterized in that the metals usable in said molten pool are tin, lead, molten alloys such as Ni—Bi or molten salts which are suitable to operate at a temperature below 1500° C.

6. The reactor according to claim 1, characterized in that the molten metal pool can contain a catalytic active metal, also melted or bound in the metal pool, so as to form a molten metal alloy, where the active metal is Ni or an alloy thereof such as nickel-gallium, or gallium and alloys thereof, or copper (Cu) and the alloy thereof or any combination of the metals mentioned, in order to increase the conversion and lower the operating temperature.

7. The reactor according to claim 1, characterized in that the electrodes are made of materials such as graphite, carbides (such as SiC, ZrC), nitrides (AlN), borides (ZrB2, ZnB2) or even zirconia stabilized with yttrium (YsZr).

8. The reactor according to claim 1, characterized in that it preferably includes a central electrode, anode, surrounded in a cage (30) by vertical electrodes, cathodes, in which the central electrode is of opposite polarity with respect to the polarity of the electrodes forming the cage, and wherein said electrode cage is supported by a structure thereof which allows the regular maintenance thereof.

9. The reactor according to claim 1, characterized in that it alternatively includes flat plates of electrodes, anodes and cathodes, arranged parallel along the reactor axis.

10. The reactor according to claim 1, characterized in that it alternatively includes flat plates of electrodes, anodes and cathodes, diametrically opposite with respect to the reactor axis.

11. The reactor according to claim 1, characterized in that it alternatively includes two electrodes of opposite polarity in the shape of a disk, one arranged on the upper part of the reactor and one on the lower part.

12. The reactor according to claim 8, characterized in that the cooling of the central electrode is obtained by preheating the natural gas feed flowing through said central electrode which has the shape of a tube.

13. The reactor according to claim 12, characterized in that the cooling of the central electrode in the form of a tube is obtained alternatively by using an external water or air cooling circuit.

14. The reactor according to claim 1, characterized in that it is suitable to operate with the voltage (V), which is applied to obtain the development of the cracking reaction, below 100 V, more preferably in the range of 5-75 V, said reactor being suitable to operate with the current intensity (I) applied is below 500 A, and in that it is suitable to operate with the current density is in the range of 1-20 A/dm².

15. A hydrocarbon cracking process for producing gaseous hydrogen and solid carbon in a medium consisting of a pool of molten metals and/or salts by means of a cracking reactor according to claim 1, characterized in that the heat required for the cracking reaction is supplied to said molten pool by the circulation of an electric current directly in said molten pool obtained by applying an electric field supplied by electrodes immersed in said molten pool.

16. The process according to claim 15, characterized in that the hydrocarbon feed is bubbled at the bottom of the molten pool, so as to generate bubbles which increase the resistivity of the molten pool itself, thus reducing the current to be supplied to said pool to develop the cracking reaction.

17. The process according to claim 15, characterized in that the metals usable in said molten pool are tin, lead, molten alloys such as Ni—Bi or molten salts which operate at a temperature below 1500° C.

18. The process according to claim 17, characterized in that said molten metal pool contains a catalytic active metal, also melted or bound in the metal pool, so as to form a molten metal alloy, where the active metal is Ni or an alloy thereof such as nickel-gallium, or gallium and alloys thereof, or copper (Cu) and the alloy thereof or any combination of the metals mentioned, in order to increase the conversion and lower the operating temperature.

19. The process according to claim 15, characterized in that the electrodes are made of materials such as graphite, carbides (such as SiC, ZrC), nitrides (AlN), borides (ZrB2, ZnB2) or even zirconia stabilized with yttrium (YsZr).

20. The process according to claim 15, characterized in that the electricity is supplied either in alternating mode (AC) or in direct mode (DC).

21. The process according to claim 20, characterized in that when the power supply occurs in direct mode (DC) with the electricity generated by a renewable source, such as photovoltaics or wind energy, the entire cracking process is completely free of CO₂ emissions.

22. The process according to claim 15, characterized in that the reaction temperature and yield parameters are controllable by modulating the voltage and intensity of current flowing inside the molten pool.

23. The process according to claim 15, characterized in that the voltage (V) to be applied to obtain the development of the cracking reaction, for a production of 100 Nm³/h of H₂ by a single reactor, is equal to about 100 V, in that the current intensity (I) applied is below 500 A, and in that the current density is in the range of 1-20 A/dm².

24. The process according to claim 23, characterized in that greater capacities are obtainable by multiplying the number of reactors, or modules, or by modifying the arrangement of the electrodes.

25. The process according to claim 15, characterized in that the raw material to be treated is any fossil hydrocarbon, either in gaseous form or in the form of organic liquid waste.

26. The process according to claim 25, characterized in that the feed is preferably natural gas.
